(19) United States
(12) Patent Application Publication
(10) Pub. No.: US 2026/0221660 A1
(43) Pub. Date: Jul. 30, 2026

(54) ANTENNA ARRAY

(71) Applicant: FRIEDRICH-ALEXANDER-UNIVERSITÄT ERLANGEN-NÜRNBERG (FAU), Erlangen (DE)

(72) Inventors: Konstantin LOMAKIN, Nürnberg (DE); Mark SIPPEL, Fürth (DE); Andreas HOFMANN, Erlangen (DE); Gerald GOLD, Erlangen (DE); Martin VOSSIEK, Fürth (DE)

(21) Appl. No.: 19/137,224

(22) PCT Filed: Dec. 8, 2023
(86) PCT No.: PCT/EP2023/084913

§ 371 Date: Jun. 9, 2025

(30) Foreign Application Priority Data
Dec. 9, 2022 (DE) 10 2022 132 832.5

(51) Int. Cl. H01Q 13/02; H01Q 21/00

(52) U.S. Cl. CPC H01Q 13/0208; H01Q 21/00

(57) ABSTRACT

The present invention relates to an antenna array having at least one antenna and a surface, wherein the antenna is arranged and designed to emit and/or receive electromagnetic waves, wherein the antenna array comprises at least one structuring, wherein the structuring is not a component of the antenna and also not a dummy antenna, wherein the antenna and the structuring each have an extension starting from the surface.

### CROSS REFERENCE TO RELATED APPLICATIONS

The present application is a U.S. National Phase of International Application No. PCT/EP 2023/084913 entitled “ANTENNA ARRAY,” and filed on Dec. 8, 2023. International Application No. PCT/EP2023/084913 claims priority to German Patent Application No. 10 2022 132 832.5 filed on Dec. 9, 2022. The entire contents of each of the above-listed applications are hereby incorporated by reference for all purposes.

### TECHNICAL FIELD

The present invention relates to an antenna array having at least one antenna and a surface, wherein the antenna is arranged and designed to emit and/or receive electromagnetic waves.

BACKGROUND AND SUMMARY Antenna arrays comprising a plurality of antennas, e.g. horn antennas, for radiating high-frequency electromagnetic waves are known from the prior art. Such antenna arrays are used in radar applications, for example.

Compared to individual antennas, antenna arrays have the ability to determine the angle of incidence of a wave based on differences in the phase delay. Further signal processing makes it possible to implement imaging radar functions with skilfully arranged antenna arrays. MIMO systems (multiple-input multiple-output) with several transmitter and receiver channels are frequently used.

It is particularly common here to endeavour to cover as wide a ‘field of view’ as possible, which means that the antenna array radiates sufficient power over a correspondingly wide aperture angle in the space.

However, interference or other effects can occur between the waves emitted by the antenna array's antennas, for example, which can reduce the uniformity of the antenna array's radiation patterns. For example, there are ripple effects in the radiation patterns of the antenna array and in the radiation patterns of the antennas of the antenna array.

FIG. 5 shows a graph showing the radiation patterns of antennas of a prior art antenna array.

The angle to the antenna array is plotted on the x-axis of the graph and the signal strength is plotted on the y-axis. The centre vertical line in the graph indicates an angle of 0°. The three lines offset to the left of this centre vertical line indicate an angle of −50°, −100° and −150° respectively. The three lines offset to the right of this centre vertical line indicate an angle of 50°, 100° and 150° respectively.

The four radiation curves A1 to A4, for example, show clear differences in angular ranges from −70° to 70°. The radiation curves also have a ripple over the entire angular range.

The radiation properties of the antennas in the antenna array are ideally such that they are identical to each other. Likewise, the radiation properties of the antennas of the antenna array as well as the radiation properties of the antenna array ideally have no ripple.

To achieve this, in the prior art, dummy antennas are often placed between the active antennas of the array. This increases the degree of symmetry such that each active antenna ‘perceives’ the same environment around it as far as possible.

However, in particular with wide fields of view—and the associated wide aperture angles of the antennas—this strategy quickly reaches its limits, so that despite the efforts with dummy antennas in the immediate vicinity of the antennas, a clear parasitic influence of the surface on which the antennas are embedded, as well as their edges and/or the surrounding enclosure, remains.

Such dummy antennas are usually copies of the actual active antennas of the array, but they are not connected to the power supply or the receiving system. Instead, they can be terminated with a defined HF termination, for example, in order to simulate the impression of a real antenna as closely as possible.

These dummy antennas are also usually positioned at the same distance from the active antennas as the active antennas themselves, with the aim of improving the geometric symmetry of the structure. In particular, they are not often placed over large parts of the surface.

Against this background, the object of the present invention is to improve an antenna array, in particular with regard to the antenna radiation properties, compared to the prior art.

This object is achieved by the subject matter with the features as described herein.

Accordingly, it is provided according to the invention that the antenna array comprises at least one structuring, wherein the structuring is not a component of the antenna and also not a dummy antenna, wherein the antenna and the structuring each have an extension starting from the surface.

Preferably, the structuring has an extension along the surface. The structuring can be an angular corrugated sheet metal structure.

The structuring preferably has a triangular or trapezoid cross-sectional shape.

Preferably, the horizontal distance between two structurings is in the range of half a free-space wavelength with permitted variations.

The structuring does not necessarily extend over the entire surface, but has interruptions. This can also be used in a simulation.

Preferably, it is provided that the surface of the structuring is partially or completely provided with an electrically conductive coating or partially or completely provided with no electrically conductive coating.

Preferably, it is provided that the structuring has a round, oval, elliptical, triangular and/or rectangular cross section.

Preferably, it is provided that the structuring has a straight longitudinal section and/or extends over the entire surface.

Preferably, it is provided that the structuring has a straight longitudinal section and/or extends over the entire surface.

Preferably, it is provided that the structuring has interruptions in the longitudinal section.

Preferably, it is provided that the structuring has interruptions in the longitudinal section and the interruptions have a distance in the longitudinal direction which is in the range of one free-space wavelength, preferably less than one free-space wavelength and in particular in the range of half a free-space wavelength.

The structuring can be multiplied along its longitudinal direction (perpendicular to its cross section and parallel to the surface) with or without interruption. Periodic and freely selectable multiplication is conceivable.

It is also conceivable that the structuring has one or more interruptions along its longitudinal alignment (perpendicular to the cross section and parallel to the surface).

The structuring can have a length along its longitudinal direction (perpendicular to its cross section and parallel to the surface) of less than the length of the entire surface, preferably a length of the order of a free-space wavelength and, in particular, a longitudinal dimension of less than a free-space wavelength.

Preferably, it is provided that the antenna array has more than one structuring, wherein the structuring below the surface is connected or not connected to another adjacent and/or non-adjacent structuring.

Preferably, it is provided that the surface has a flat, curved, round, concave, convex and/or mathematically describable shape.

Preferably, it is provided that the structuring is at least partially filled with air and/or with a dielectric.

Preferably, it is provided that the antenna array is in one piece.

Preferably, it is provided that the antenna array is manufactured using an additive manufacturing process.

Preferably, it is provided that the structuring has a centre roughness value above 0.5, preferably above 1.5, particularly preferably above 3.

The antenna array can have one or a plurality of antenna.

The antenna can be arranged in a planar manner on the surface. The antenna can also be recessed into the surface or arranged on or above the surface.

In principle, the surface can be any shape.

Preferably, it is provided that the surface has a flat, curved, round, concave, convex and/or mathematically describable shape.

The structuring can be round, oval, elliptical, triangular and/or rectangular in cross section, preferably transverse to an elongated extension of the structuring. The cross section can also change over the length. The structuring can preferably be any shape. Particularly preferably, the structuring is triangular in cross section. Thus, the structuring can be similar to a corrugated sheet metal roof.

The structuring can be of any shape and any length in longitudinal section, preferably along an elongated extension of the structuring along the surface. It is particularly preferable for the structuring to be straight and continuous over the entire surface.

Preferably, it is provided that the antenna array has more than one structuring, wherein the structuring below the surface is connected or not connected to another adjacent and/or non-adjacent structuring.

More than one structuring with a surface density of less than 100 structurings per square centimetre, preferably less than 50 structurings per square centimetre, in particular less than 10 structurings per square centimetre, can be arranged on the surface.

It is conceivable that the structuring is arranged in sections on the surface with different surface densities.

The structuring can be arranged in any arrangement pattern with more than one other structuring.

More than one structuring can be arranged at a periodic distance from each other, both in the longitudinal and transverse direction (both directions lie on the surface). And this is also possible non-periodically.

It is conceivable, for example, that the, in particular periodic, distance between two structurings is a quarter or half of the wavelength of an electromagnetic wave emitted from an antenna and/or received by the antenna. The distance between two structurings is preferably determined between the centre lines or the boundaries of the structuring.

It is also conceivable that the distance between the structuring deviates from a quarter or half a wavelength by around 10-30%.

Preferably, the structuring is arranged in the immediate vicinity of one or more antennas.

Preferably, the structuring is arranged between two or more antennas.

It is conceivable that structurings are arranged throughout the surface. However, it is also conceivable that structurings are only arranged in sections, e.g. in the vicinity of an antenna or the antennas.

One or more antennas can be flush with the surface on or near which the structurings are arranged. However, one or more antennas can also protrude above the surface or be arranged below the surface.

The structuring can protrude from the surface. For example, the edge of a structuring can protrude from the surface like a kind of stamp, for example with a protrusion of, in particular, a few 100 μm. The structuring can protrude with the same protrusion or a different protrusion as another structuring. Several structures with different protrusions can also protrude.

One or more structurings can also be arranged on or in a side wall of the antenna array. This could reduce parasitic interactions with an enclosure.

The antenna array can be manufactured at least partially by injection moulding, turning and/or milling. Preferably, the antenna array is manufactured at least partially by an additive method.

One or more antennas and/or one or more structurings can also be arranged on one or more printed circuit boards. The antenna array can comprise a printed circuit board. One or more antennas can be planar antennas, e.g. patch antennas or substrate-integrated hollow waveguide antennas. It is conceivable that the structuring is applied by milling and preferably metallised afterwards.

The antenna array can be manufactured at least partially by means of plastic 3D printing, preferably with subsequent metallisation, or metal 3D printing, preferably with subsequent coating.

The antenna array can be manufactured at least partially using a casting method.

In principle, the antenna array can also be produced using other manufacturing processes.

The antenna array can be manufactured separately, stacked and assembled. It is particularly preferable for the antenna array to be manufactured in one piece, i.e. monolithically.

In particular, slotted hollow waveguides can be used in the production of the antenna array.

One or more antennas and/or their feed can also be designed as slotted hollow waveguides and can, in particular, be part of the antenna array.

The surface can have a recess in addition to the structuring or structurings.

In principle, the surface can be any shape.

The surface can also have additional recessed elements.

Preferably, it is provided that the structuring on the surface is circular, semi-circular, elliptical, round and/or follows any free form and/or any mathematical shape.

Preferably, it is provided that the cross section of the structuring is triangular and/or trapezoid, wherein the distance between two structurings is in the range of half a free-space wavelength and the depth of the structuring projecting into the surface is in the order of 0.2 to 0.7 free-space wavelengths.

Preferably, it is provided that the structurings are placed on the side walls and/or on the enclosure of the array.

Preferably, it is provided that the structurings are placed on a component adjacent to the antenna array, in particular on the enclosure, in which the antenna array and/or an underlying circuit carrier are integrated and preferably on other surfaces interacting with the electromagnetic field of the wave.

In the context of the present invention, the term “antenna array” is to be understood as a set of several, preferably connected antennas. However, contrary to the common understanding according to the present invention, the term “antenna array” comprises only a single antenna.

At this point it is pointed out that the terms “a” and “one” do not necessarily refer to exactly one of the elements, although this is a possible embodiment, but can also denote a plurality of the elements. Similarly, the use of the plural also includes the presence of the element in question in the singular and, conversely, the singular also includes several of the elements in question. Furthermore, all of the features of the invention described herein may be claimed in any combination or in isolation from each other.

### BRIEF DESCRIPTION OF THE FIGURES

Further advantages, features and effects of the present invention are shown in the following description of preferred exemplary embodiments with reference to the figures, in which the same or similar components are designated by the same reference numerals. In the figures:

FIG. 1: shows a perspective view of an embodiment of an antenna array according to the invention.

FIG. 2: shows a side view of the antenna array according to the invention.

FIG. 3: shows a perspective view of a further embodiment of an antenna array according to the invention.

FIG. 4: shows a top view of the further embodiment of an antenna array according to the invention.

FIG. 5 shows a graph showing the radiation pattern of a prior art antenna array.

FIG. 6: shows a graph showing the radiation pattern of an antenna array according to the invention.

### DETAILED DESCRIPTION

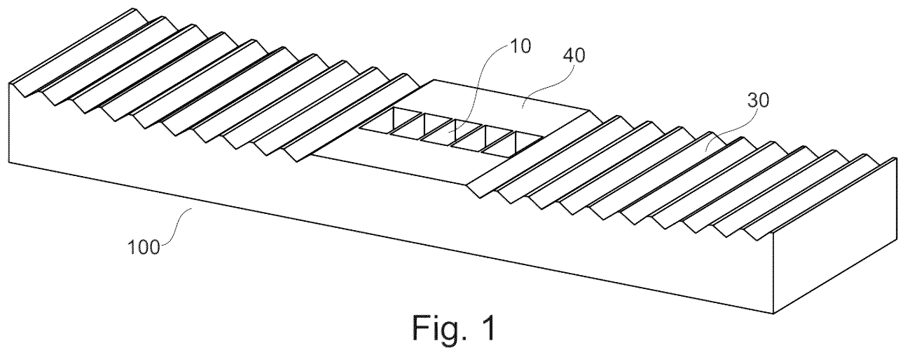

FIG. 1 shows an exemplary antenna array 100 having five antenna 10 arranged in the centre and, in sections, having a structuring 30, which in the present example has a triangular cross section.

The antennas 10 are horn antennas. The structuring 30 is in the form of corrugated sheet metal. The antenna array 100 also has unstructured regions 40.

The upper surface of the antenna array 100 is the surface from which the electromagnetic waves emitted and/or received from the antennas 10 are emitted or received.

The antenna array 100 has a rectangular shape.

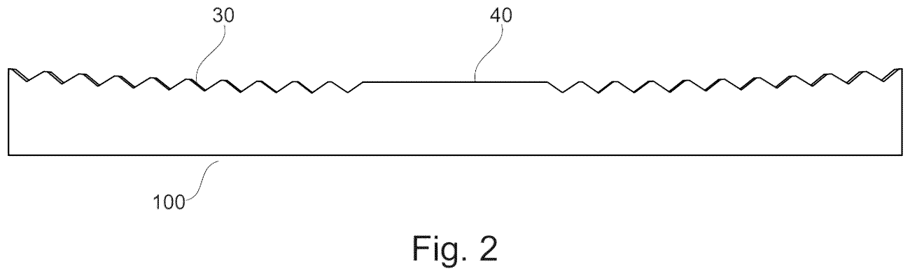

As can be seen from FIG. 2, the surface of the antenna array 100 is slightly curved.

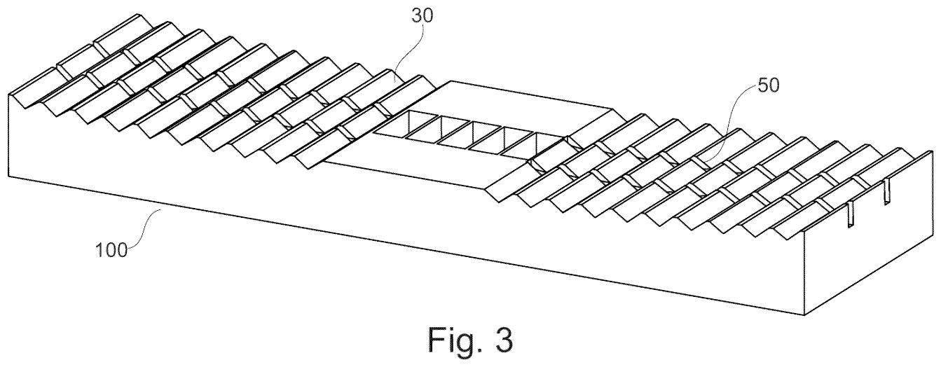

FIG. 3 shows an antenna array 100 having a structuring 30, wherein the structuring 30 has interruptions 50.

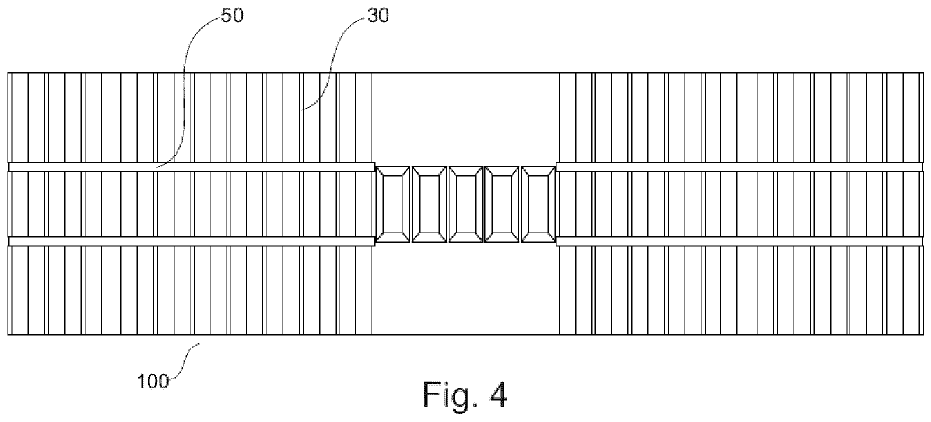

FIG. 4 shows a top view of FIG. 3.

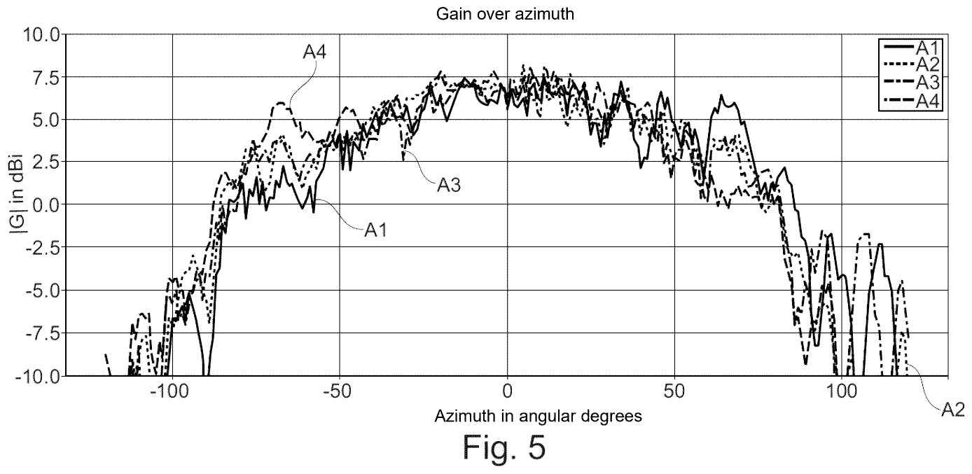

FIG. 5 is described above.

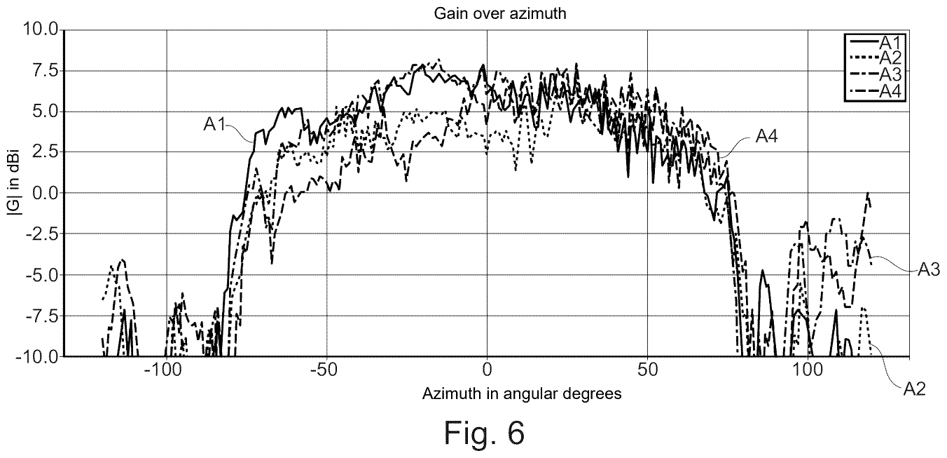

FIG. 6 shows a graph showing the radiation patterns of antennas of an antenna array according to the invention.

The angle to the antenna array is plotted on the x-axis of the graph and the signal strength is plotted on the y-axis. The centre vertical line in the graph indicates an angle of 0°. The three lines offset to the left of this centre vertical line indicate an angle of −50°, −100° and −150° respectively. The three lines offset to the right of this centre vertical line indicate an angle of 50°, 100° and 150° respectively.

The function of the antenna array 100 is changed by the structuring in such a way that the directional pattern assumes a course that is orientated closer to the rectangular shape over the solid angle. Compared to FIG. 4, this effect is only achieved by the structuring and shaping of the surface.

1. An antenna array having at least one antenna and a surface, wherein the antenna is arranged and designed to emit and/or receive electromagnetic waves, wherein the antenna array comprises structurings, wherein the structurings are not components of the antenna and also not dummy antennas, wherein the antenna and the structurings each have an extension starting from the surface, wherein the distance between two structurings is a quarter ±30% of the wavelength of said wave.

2. The antenna array according to claim 1, wherein the surface of the structurings is partially or completely provided with an electrically conductive coating or partially or completely provided with no electrically conductive coating.

3. The antenna array according to claim 1, wherein the structurings have a round, oval, elliptical, triangular and/or rectangular cross section.

4. The antenna array according to claim 1, wherein the structurings have a straight longitudinal section and/or extend over the entire surface.

5. The antenna array according to claim 1, wherein the structurings on the surface are circular, semi-circular, elliptical, round and/or follows any free form and/or any mathematical shape.

6. The antenna array according to claim 1, wherein the cross section of the structurings is triangular and/or trapezoidal, wherein the distance between two structurings is in the range of half a free-space wavelength and the depth of the structurings projecting into the surface is in the order of 0.2 to 0.7 free-space wavelengths.

7. The antenna array according to claim claims, wherein the structurings have interruptions in the straight longitudinal section.

8. The antenna array according to claim 4, wherein the structurings have interruptions in the straight longitudinal section and the interruptions have a distance in the longitudinal direction which is in the range of one free-space wavelength.

9. The antenna array according to claim 4, wherein the structurings have interruptions in the straight longitudinal section and the interruptions are arranged periodically or non-periodically.

10. The antenna array according to claim 1, wherein the antenna array has more than one structuring, wherein the structurings below the surface are connected or not connected to another adjacent and/or non-adjacent structuring.

11. The antenna array according to claim 1, wherein the surface has a flat, curved, round, concave, convex and/or mathematically describable shape.

12. The antenna array according to claim 1, wherein the structurings are at least partially filled with air and/or with a dielectric.

13. The antenna array according to claim 1, claims, wherein the antenna array is in one piece and/or in that the antenna array is manufactured using an additive manufacturing process.

14. (canceled)

15. The antenna array according to claim 1, claims, wherein the structurings have a centre roughness value above 0.5, and/or in that the structurings are placed on side walls and/or on an enclosure of the array.

16. (canceled)

17. The antenna array according to claim 1, claims, wherein the structurings are placed on a component adjacent to the antenna array, in which the antenna array and/or an underlying circuit carrier are integrated.

18. The antenna array according to claim 1, wherein the distance between two structurings is a quarter ±10% of the wavelength of said wave.

19. The antenna array according to claim 4, wherein the structurings have interruptions in the straight longitudinal section and the interruptions have a distance in the longitudinal direction which is less than one free-space wavelength.

20. The antenna array according to claim 19, wherein the interruptions have a distance in the longitudinal direction which is in the range of half a free-space wavelength.

21. The antenna array according to claim 15, wherein the centre roughness value is above 1.5.

22. The antenna array according to claim 17, wherein the component adjacent to the antenna array is an enclosure of the antenna array.
